(19) United States
(12) Patent Application Publication
(10) Pub. No.: US 2006/0028846 A1
(43) Pub. Date: Feb. 9, 2006

(54) Connection device for solar panels in a solar powered lantern to enable thesolar panels to extend horizontally to the solar powered lantern

(76) Inventor: Hsiao-Chung Yang, Chungho City (TW)

Correspondence Address: DELLETT & WALTERS, P. O. BOX 82788, PORTLAND, OR, 97282-0788, US

(21) Appl. No.: 10/912,851

(22) Filed: Aug. 6, 2004

(51) Int. Cl. H01R 33/00

(52) U.S. Cl. 362/640

(57) ABSTRACT

A connection device for carrying thereon solar panels for a solar lantern includes a loop body for carrying thereon the solar panels, the loop body having at least one ear mounted on an outer periphery of the loop body, and a clamp having two pairs of pivot rods oppositely formed on the clamp, one of the two pairs of pivot rods being pivotally connected to the at least one ear and the other one of the two pairs of pivot rods being adapted for connection to another loop body. Multiple loop bodies are stacked on top of one another with variations of dimension change of the clamp.

### BACKGROUND OF THE INVENTION

1. Field of the Invention

The present invention relates to a connection device, and more particularly to a connection device for solar panels in a solar powered lantern to enable the solar panels to extend horizontally relative to the lantern such that the lantern is able to absorb maximum solar energy and give off maximum illumination while the volume of the lantern is compact.

2. Description of Related Art

With reference to FIGS. 7 and 8, a conventional solar powered lantern is shown and has a body (5) with an illuminating element (51) mounted inside the body (5) and an arm (6) pivotally connected to the body (5) and received in a recess (52) defined in a periphery of the body (5). The arm (6) has multiple solar panels (61) mounted on an outer face thereof. Therefore, when the conventional solar lantern is in use, the user pivots the arm (6) to extend the arm (6) transversely from a side of the body (5) so that the conventional solar lantern is able to absorb solar energy via the solar panels on a top face of the arm (6).

From the depiction of the drawing, it is noted that because the arm (6) is pivotally connected to a side face of the body (6) an area of the body (5) is not able to emit light due to the blockage by the arm (6). As a result of the blockage, the use of the conventional solar lantern is not convenient and not able to deliver enough illumination as expected.

To overcome the shortcoming, the present invention tends to provide an improved connection device for the solar panels to mitigate the aforementioned problems.

### SUMMARY OF THE INVENTION

The primary objective of the present invention is to provide an improved connection device for solar panels in a solar powered lantern so that the solar panels are able to be extended horizontally relative to the body of the solar lantern and light is able to be emitted from every portion of the body of the solar lantern.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of the connection device of the present invention;

FIG. 2 is a perspective view showing that multiple connection devices are stacked on top of the other;

FIG. 3 is a perspective view showing the mounting position of the connection device of the present invention;

FIGS. 4-6 are schematic views showing the engaging arrangement of the connection devices;

FIG. 7 is a side view of the conventional solar lantern; and

FIG. 8 is a perspective view of the conventional solar lantern with the arm extended to allow the solar panels to absorb solar energy.

### DETAILED DESCRIPTION OF THE PREFERRED EMBODIMENT

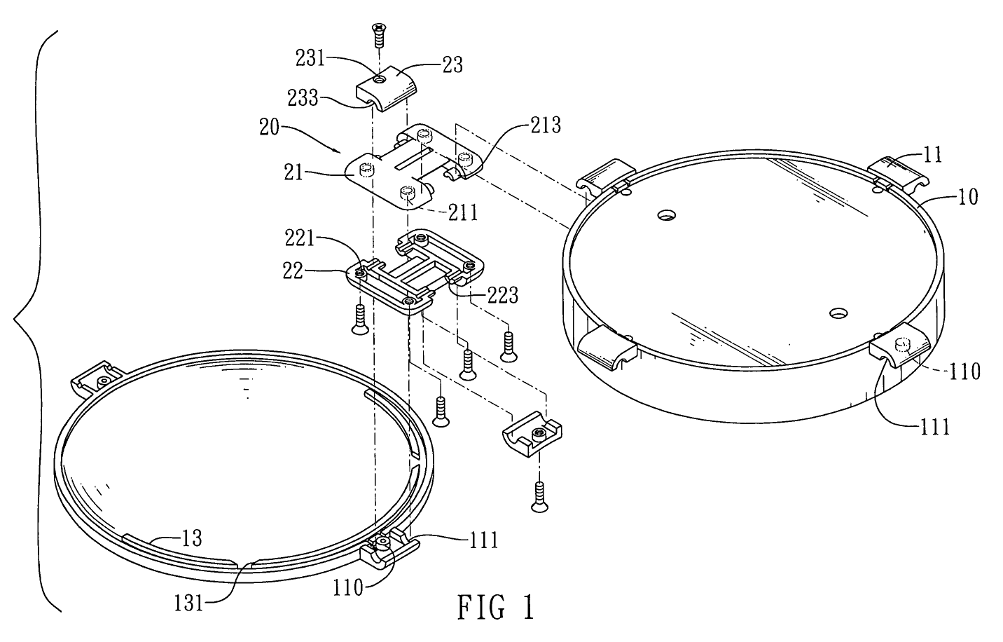

With reference to FIG. 1, the connection device in accordance with the present invention includes a loop body (10) and a clamp (20).

The loop body (10) is substantially circular and has at least one ear (11) (four ears (11) are shown in this embodiment) extending out from an outer periphery of the loop body (10) and multiple intermittently arranged bars (13) formed on a bottom peripheral edge of the loop body (10). The ear (11) has a connection hole (110) defined therein and a first arcuate recess (111) defined in a periphery defining the connection hole (110).

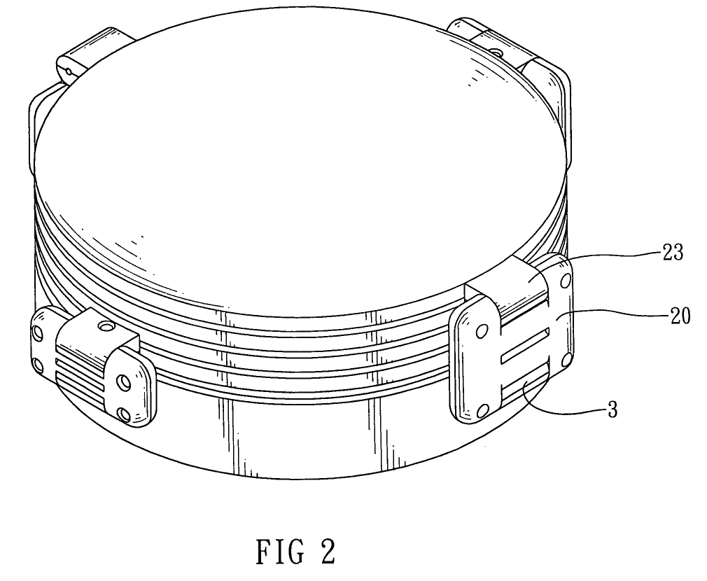

The clamp (20) is composed of a top cover (21) and a bottom cover (22). The top cover (21) has multiple engaging holes (211) defined in comers of the top cover (21) and two pairs of first half rods (213) oppositely extending out from the top cover (21) with the two first half rods (213) in each pair facing each other. The bottom cover (22) has multiple threaded holes (221) extending out to correspond to and align with the engaging holes (211) to allow multiple securing elements (not numbered) such as bolts, screws or the like to extend into the aligned threaded holes (221) and the engaging holes (211) and two pairs of second half rods (223) oppositely extending out from the bottom cover (22) with the two second half rods (223) in each pair facing each other. The two pairs of second half rods (223) correspond to the two pairs of first half rods (213) so as to form two pairs of pivot rods (3) (as shown in FIG. 2) when the top cover (21) and the bottom cover (22) are combined with the securing elements inserted into the corresponding threaded holes (221) and the engaging holes (211).

Furthermore, a covering (23) is provided with a screw hole (231) extending out to correspond to the connection hole (110) of the loop body (10), and a second arcuate recess (233).

With reference to FIG. 2 and still using FIG. 1 for reference, it is noted that when the connection device of the present invention is assembled, one pair of the pivot rods (3) is received and sandwiched between the first arcuate recess (111) and the second arcuate recess (233) after the top cover (21) and the bottom cover (22) are combined. Meanwhile the screw hole (231) of the covering (23) is aligned with the connection hole (110) to allow one of the securing elements to be screwingly extend therethrough so as to complete the assembly of the connection device of the present invention.

From the depiction of FIG. 1, it is noted that gaps (131) are defined between each adjacent two of the bars (13) such that electrical wires (not shown) are able to extend out from the gaps (131) to connect to an illumination element (not shown) in the solar lantern. Furthermore, when there are two ears (11) diametrically arranged on the outside face of the loop body (10) and when a first of the ears (11) is used to connect the loop body to a lantern, the loop body (10) is able to connect to another loop body (10) by means of the other ear (11). The top face of the loop body (10) is mounted with a solar panel, which is conventional in the art such that detailed description thereof is thus omitted.

From the perspective view shown in FIG. 2, it is noted that multiple loop bodies (10) are able to be stacked on top of one another with variations of dimensions of the top and bottom covers (21,22). That is, in order to stack multiple loop bodies (10) together, the dimension of the clamp (20) needs to be changed (lengthened). Therefore, as the stack of the loop bodies (10) becomes higher and higher, the dimension of the clamp (20) becomes longer.

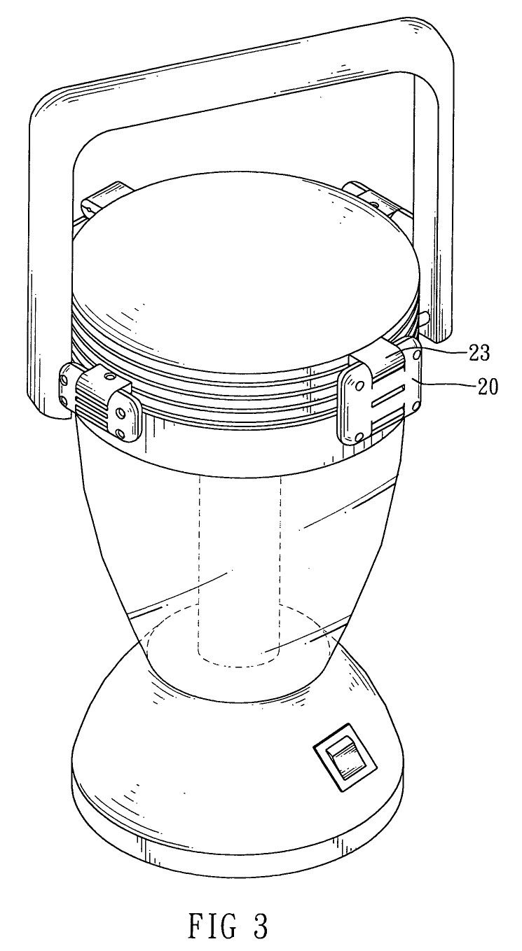

With reference to FIG. 3, it is noted that with the design of the connection device of the present invention, the solar panels are all on top of the solar powered lantern so that the illumination from the lantern will not be blocked. Therefore, light can be emitted from all angles of the solar lantern.

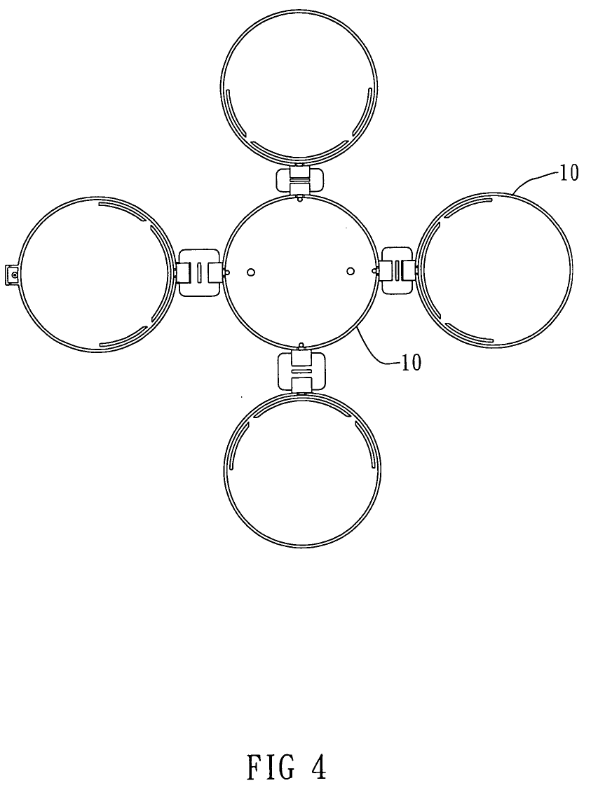

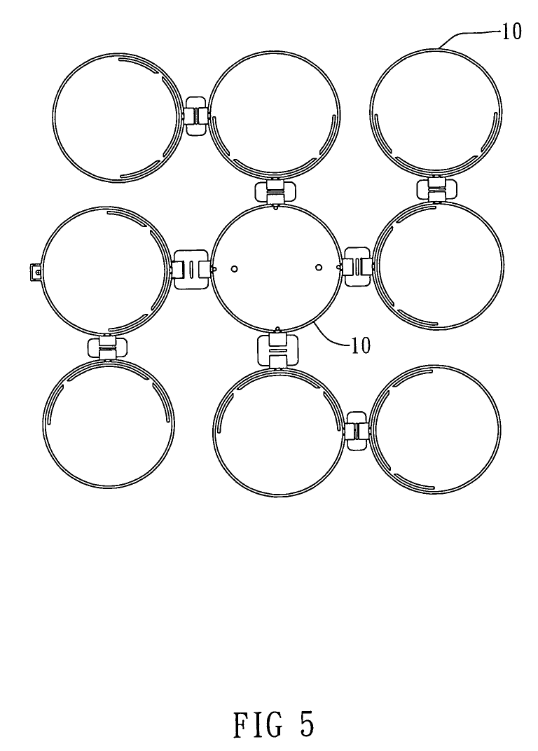

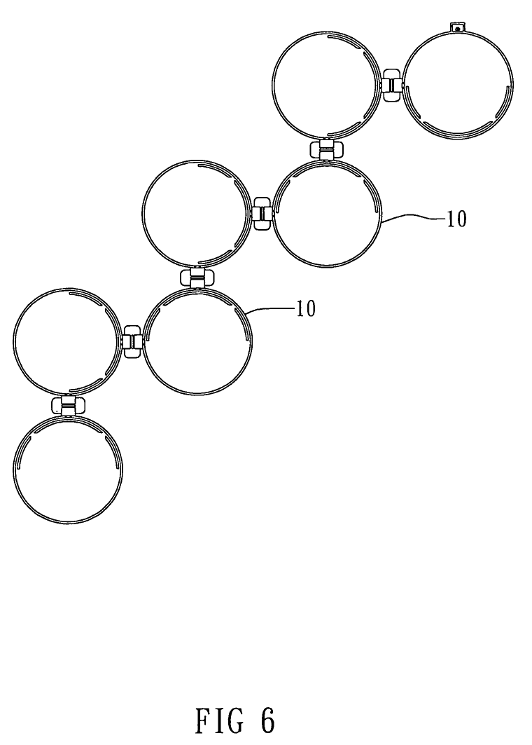

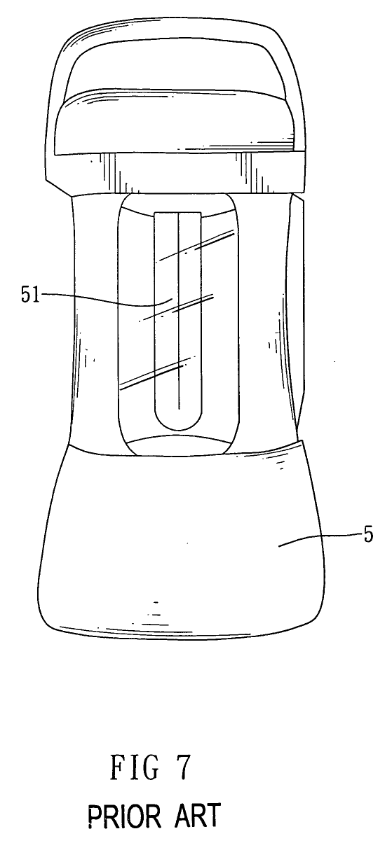

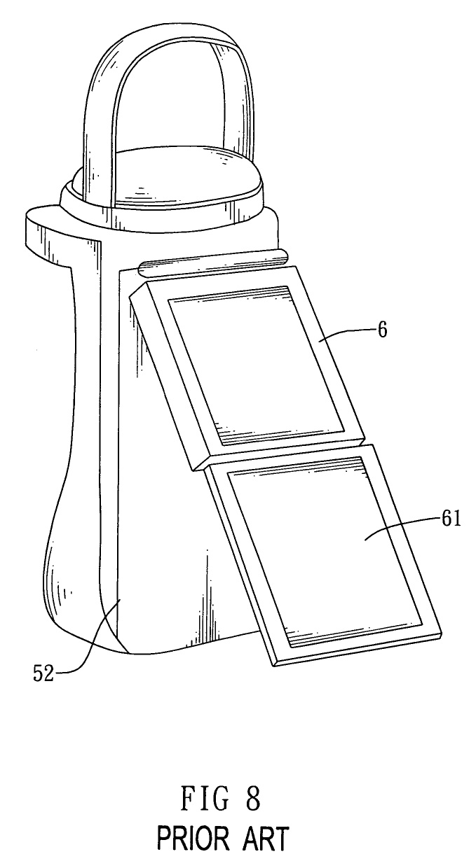

With reference to FIGS. 4 to 6, it is noted that the loop body (10) can be connected to four, six, eight, etc., other loop bodies (10) as long as the arrangement of the other loop bodies (10) are diametrically arranged relative to the one immediately on top of the lantern.

After the connection device of the present invention is mounted on top of the lantern, the loop bodies (10) are able to be extended outward sequentially based on the stacking sequence of the loop bodies (10). Thus the solar panels on top of the loop bodies (10) are able to evenly absorb solar energy and recharge the solar batteries in the lantern.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A connection device adapted to be mounted on top of a solar powered lantern and adapted for carrying thereon solar panels for the solar powered lantern, the connection device comprising:
a loop body for carrying thereon solar panels, the loop body having at least one ear mounted on an outer periphery of the loop body; and
a clamp having two pairs of pivot rods oppositely formed on the clamp, one of the two pairs of pivot rods being pivotally connected to the at least one ear and the other one of the two pairs of pivot rods being adapted for connection to another loop body,
wherein multiple loop bodies are stacked on top of one another via variations of dimension change of the clamp.

2. The connection device as claimed in claim 1, wherein the at least one ear has a first arcuate recess and the clamp has a second arcuate recess defined in a covering such that combination of the first arcuate recess and the second arcuate recess is able to receive therein one of the two pairs of pivot rods.

3. The connection device as claimed in claim 2, wherein the clamp further comprises:
a top cover having multiple engaging holes; and
a bottom cover having multiple threaded holes corresponding to the engaging holes so that after alignment between the threaded holes and the corresponding engaging holes, securing elements are able to extend through the aligned threaded holes and the engaging holes and thus the top cover and the bottom cover are formed into the clamp.

4. The connection device as claimed in claim 3, wherein the top cover has two pairs of first half rods oppositely formed on the top cover and the bottom cover has two pairs of second half rods oppositely formed on the bottom cover to respectively correspond to the first half rods of the top cover so as to form the two pairs of pivot rods.

5. The connection device as claimed in claim 2, wherein the covering further has a threaded hole corresponding to a connection hole in the at least one ear to secure the pivotal engagement of the clamp to the at least one ear via a securing element.

6. The connection device as claimed in claim 3, wherein the covering further has a threaded hole corresponding to a connection hole in the at least one ear to secure the pivotal engagement of the clamp to the at least one ear via one of the securing elements.

7. The connection device as claimed in claim 4, wherein the covering further has an threaded hole corresponding to a connection hole in the at least one ear to secure the pivotal engagement of the clamp to the at least one ear via one of the securing elements.

8. The connection device as claimed in claim 7, wherein the loop body has two ears diametrically formed on the loop body.

9. The connection device as claimed in claim 7, wherein the loop body has four ears evenly distributed on the loop body.
